(19) United States
(12) Patent Application Publication
(10) Pub. No.: US 2019/0048966 A1
(43) Pub. Date: Feb. 14, 2019

(54) SHOCK ABSORBER

(71) Applicant: KYB CORPORATION, Tokyo (JP)

(72) Inventor: Norihiko Kurita, Tokyo (JP)

(73) Assignee: KYB CORPORATION, Tokyo (JP)

(21) Appl. No.: 16/055,569

(22) Filed: Aug. 6, 2018

(30) Foreign Application Priority Data
Aug. 10, 2017 (JP) 2017-155724

(51) Int. Cl. F16F 9/43; B62K 25/04; F16F 9/32; F16F 9/34; F16F 9/44

(52) U.S. Cl. CPC F16F 9/435; B62K 25/04; B62K 2025/048; F16F 9/34; F16F 9/446; F16F 9/325

(57) ABSTRACT

A shock absorber according to the present invention includes a shock absorber main body in which an internal air pressure is set to a pressure exceeding an atmospheric pressure, a relief valve configured to open when the air pressure in an air chamber of the shock absorber main body reaches a valve opening pressure, and a lock device capable of maintaining the relief valve in a closed state, and the air pressure in the shock absorber main body can be adjusted to the valve opening pressure of the relief valve.

### CROSS-REFERENCE TO RELATED APPLICATIONS

This application is based on and claims the benefit of priority from Japanese Patent Application No. 2017-155724, filed on Aug. 10, 2017, the entire contents of which are incorporated herein by reference.

### BACKGROUND OF THE INVENTION

### Technical Field

The present invention relates to a shock absorber.

### Related Art

The shock absorber is interposed between a vehicle body and wheels of the vehicle to suppress the vibration of the vehicle body and improve the riding comfort of the vehicle. In some cases, the shock absorber may be used as a suspension called a front fork which is interposed between front wheels of the straddle-riding vehicle and the vehicle body to suspend the front wheels. Such a shock absorber is provided with an outer tube, an inner tube to be inserted into the outer tube, two chambers which expand and contract with expansion and contraction, and a damping device including a damping valve which gives resistance to the flow of hydraulic oil flowing between these chambers and exerts a damping force at the time of expansion and contraction. Further, for example, as disclosed in JP 2010-185572 A, inside the shock absorber, a gas having a pressure equal to or higher than the atmospheric pressure is enclosed, and the gas constitutes an air spring which serves as a suspension spring for urging the shock absorber in an expansion direction.

Further, an opening of the outer tube is closed by a cap member, and the cap member is provided with an air valve that enables the supply and discharge of the gas into and from the shock absorber. Thus, it is possible to adjust the riding comfort of the vehicle by adjusting the urging force of the air spring.

However, at the time of traveling of the vehicle, vibration is input to the wheels and the shock absorber expands and contracts many times. Then, since the shock absorber converts the kinetic energy at the time of expansion and contraction into thermal energy to absorb the vibration of the vehicle body, the temperature of the hydraulic oil rises. When the temperature of the hydraulic oil rises, since heat propagates and the temperature of the gas also rises, the air pressure in the shock absorber rises. Further, when the shock absorber expands and contracts many times, the hydraulic oil in the shock absorber is agitated, gas dissolved in the hydraulic oil is precipitated, and the air pressure in the shock absorber rises.

When the shock absorber continues expansion and contraction in this way, since the internal air pressure rises and the urging force of the air spring increases, there is a risk of deterioration of the riding comfort of the vehicle.

In particular, when traveling on a wasteland, since expansion and contraction are repeated with a large stroke, the phenomenon more remarkably appears.

Therefore, in the conventional shock absorber, when the air pressure inside the shock absorber rises and the riding comfort of the vehicle deteriorates, it is necessary to inject gas, while measuring the pressure inside the shock absorber to an original preferable pressure (a proper pressure), using an inflator with air gauge after pulling out the air inside the shock absorber. However, the operation thereof was very troublesome.

In view of the above, an object of the present invention is to provide a shock absorber which easily restores the riding comfort of a vehicle to a satisfactory state, even if the air pressure in the shock absorber rises and the riding comfort of the vehicle deteriorates.

### SUMMARY OF THE INVENTION

Means for solving the above-mentioned problems includes a relief valve configured to open when the air pressure in the shock absorber main body in which an internal air pressure is set to a pressure exceeding an atmospheric pressure reaches a valve opening pressure, and a lock device capable of maintaining the relief valve in a closed state.

### BRIEF DESCRIPTION OF THE DRAWINGS

FIG. 1 is a schematic view illustrating the whole of a shock absorber according to the present embodiment;

FIG. 2 is a view illustrating a specific configuration of a pressure regulating device according to the present embodiment; and

FIG. 3 is a perspective view of a holder according to the present embodiment.

### DESCRIPTION OF THE EMBODIMENTS

Hereinafter, the present embodiment will be described with reference to the drawings. Same reference numerals given throughout the several views indicate same parts.

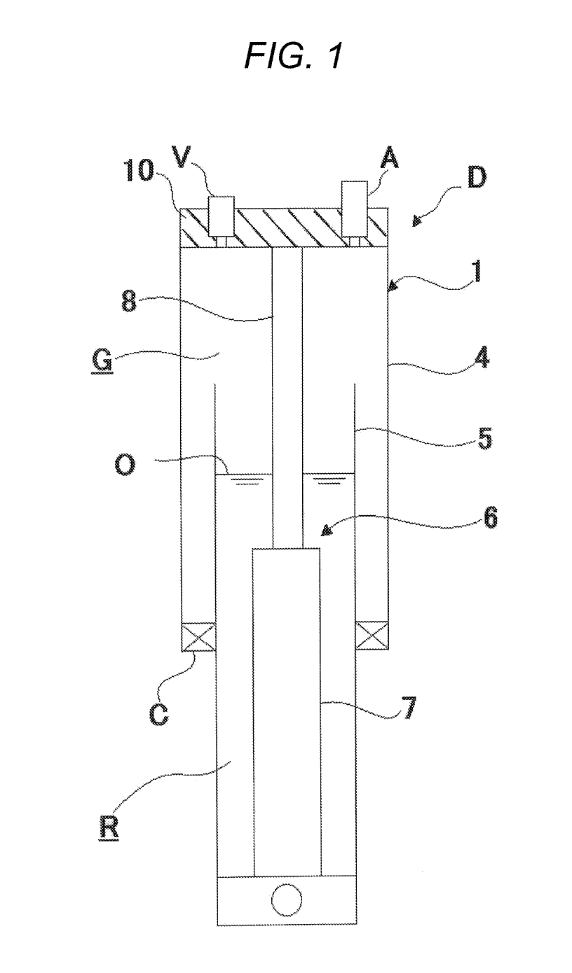

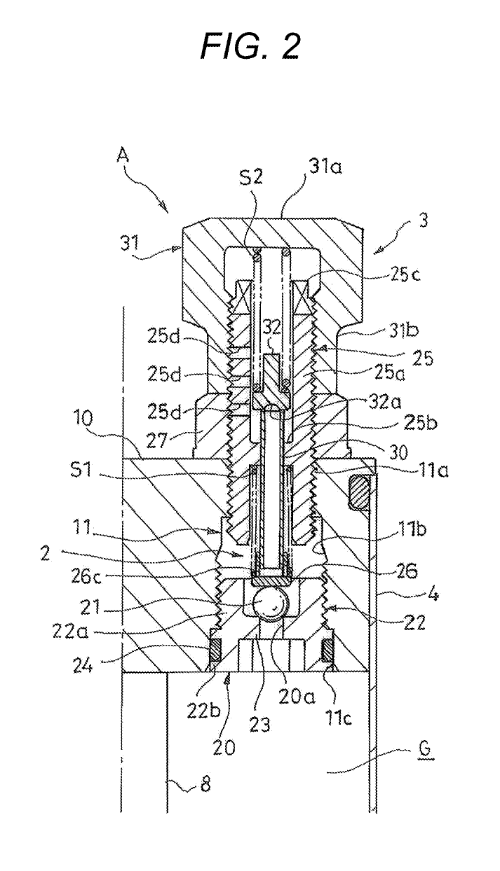

As illustrated in FIGS. 1 and 2, a shock absorber D according to the present embodiment includes a pressure regulating device A which has a shock absorber main body 1 in which an internal air pressure is set at a pressure exceeding the atmospheric pressure, a relief valve 2 which opens when the air pressure in the shock absorber main body 1 reaches a valve opening pressure, and a lock device 3 capable of maintaining the relief valve 2 in a closed state.

Hereinafter, describing in detail, the shock absorber D of the present example constitutes a front fork which is provided on the front wheel side of the straddle-riding vehicle and suspends the wheels at the lower end portion. The shock absorber main body 1, which is an outer shell of the shock absorber D, includes an outer tube 4 in which an upper end portion is connected to a handle (not illustrated) side, an inner tube 5 inserted into the outer tube 4 to enter and exit and having a lower end portion connected to the front wheel (not illustrated) side, and a damping device 6 housed in the inner tube 5 and the outer tube 4, and is formed in a telescopic shape. The damping device 6 similarly expands and contracts in accordance with expansion and contraction of the outer tube 4 and the inner tube 5 to exert a predetermined damping force.

In this example, although the shock absorber main body 1 is an inverted type, the shock absorber main body 1 may be an upright type in which the outer tube 4 is connected to the wheel side and the inner tube 5 is connected to the vehicle body side.

Further, a seal member C, which is in sliding contact with the outer circumferential surface of the inner tube 5, is mounted on the inner periphery of the lower end of the outer tube 4, and the inside of the shock absorber main body 1 is maintained in a sealed state.

Further, the configuration of the damping device 6 is a known damping device, and although not illustrated in detail, the damping device 6 includes a cylinder 7 which stands upright on an axial center portion of the inner tube 5 and is filled with a hydraulic liquid therein, a rod 8 which is inserted into the cylinder 7 and moves inside the cylinder 7 in an axial direction with expansion and contraction of the shock absorber main body 1, a piston which is held by a distal end of the rod 8 and partitions the inside of the cylinder 7 into two chambers, a passage formed in the piston to allow the two chambers to communicate with each other, and a damping valve which imparts resistance to the flow of the hydraulic liquid passing through the passage. In the damping device 6 of this example, as illustrated in FIG. 1, the cylinder 7 is connected to the inner tube 5 and the rod 8 is connected to the outer tube 4. However, in an upside-down manner, the cylinder 7 may be connected to the outer tube 4, and the rod 8 may be connected to the inner tube 5. Further, the configuration of the damping device is not limited to the above-described configuration, and other configurations may be adopted.

Further, when the shock absorber main body 1 expands and contracts, since the rod 8 enters and exits inside the cylinder 7, and the hydraulic liquid in one chamber compressed by the piston moves to the other chamber expanded by passing through the damping valve, the damping device 6 exerts a damping force caused by the resistance of the damping valve and can suppress the expansion and contraction movement of the shock absorber main body 1.

As illustrated in FIG. 1, a reservoir R in which the hydraulic liquid is stored is formed between the shock absorber main body 1 and the damping device 6. Further, when the rod 8 enters the cylinder 7, the hydraulic liquid in the cylinder 7 which is excessive by the rod entrance volume in the cylinder 7 is discharged to the reservoir R. When the rod 8 exits from the inside of the cylinder 7, the hydraulic liquid is deficient in the cylinder 7 by the rod exiting volume, but the deficient hydraulic liquid is supplied from the reservoir R.

Further, as illustrated in FIG. 1, the upper opening of the outer tube 4 is closed by a cap member 10 screwed with the inner periphery of the upper end portion. In the shock absorber main body 1, gas is sealed with a liquid level o of the hydraulic liquid of the reservoir R as a boundary, and an air chamber G is formed. The cap member 10 is provided with an air valve V capable of supplying and discharging gas to and from the air chamber G, and a pressure regulating device A.

Further, gas is enclosed in the air chamber G via the air valve V so as to be equal to or higher than the atmospheric pressure when the shock absorber main body 1 is the most elongated, and the shock absorber main body 1 is configured such that the gas in the air chamber G functions as an air spring and is urged in the expansion direction. The shock absorber D of this example functions as a suspension spring in which the air spring which is the gas in the air chamber G urges the shock absorber main body 1 in the expansion direction, and is a so-called air suspension.

Hereinafter, a specific configuration of the pressure regulating device A will be described with reference to FIG. 2. The pressure regulating device A of this example includes a relief valve 2 which is provided in a communicating hole 11 through which the air chamber G in the shock absorber main body 1 opened in the cap member 10 communicates with the atmosphere side outside the shock absorber main body, and opens when the air pressure in the air chamber G in the shock absorber main body 1 reaches the valve opening pressure, and a lock device 3 that can maintain the relief valve 2 in a closed state.

The communicating hole 11 has, in order from the atmosphere side to the air chamber G side, a small-diameter portion 11a, an intermediate diameter portion 11b having an inner diameter greater than that of the small-diameter portion 11a, and a large-diameter portion 11c having an inner diameter greater than that of the intermediate diameter portion 11b, and a screw groove (not denoted) is formed in the small-diameter portion 11a and the intermediate diameter portion 11b.

The relief valve 2 includes a valve seat member 20 that is mounted to the lower end of the communicating hole 11 in the drawing and has a port 20a communicating with the air chamber G in the shock absorber main body 1, a valve body 21 which separates from and seats on the valve seat member 20 and opens and closes the port 20a, and an urging spring S1 which urges the valve body 21 toward the valve seat member 20.

Specifically, as illustrated in FIG. 2, the valve seat member 20 has a cylindrical main body portion 22, and an annular seat portion 23 provided on the inner circumferential portion of the main body portion 22, and the inside of the seat portion 23 serves as the port 20a.

The main body portion 22 has a small-diameter cylinder portion 22a in which the outer periphery is screwed to the lower end of the intermediate diameter portion 11b of the communicating hole 11, and a large-diameter cylinder portion 22b having an outer diameter greater than the small-diameter cylinder portion 22a and fitted to the large-diameter portion 11c of the communicating hole 11.

An annular groove (not denoted) is formed on the outer periphery of the large-diameter cylinder portion 22b, and an O-ring 24 is mounted to the annular groove. As a result, the gas in the air chamber G does not leak from the gap between the outer periphery of the valve seat member 20 and the cap member 10. Further, the inner periphery of the large-diameter cylinder portion 22b has a shape matching the shape of the attachment tool of the valve seat member 20.

Although the valve seat member 20 of this example is formed separately from the cap member 10, they may be integrally formed. In that case, the number of parts of the shock absorber D can be reduced. However, if the valve seat member 20 is formed separately from the cap member 10 as in this example, it is advantageous in that the valve seat member 20 can be replaced with a new one when deteriorated by long-term use.

The valve body 21 is formed in a spherical shape and accommodated in a space formed by the seat portion 23 and the small-diameter cylinder portion 22a. When the relief valve 2 is closed, the valve body 21 seats on the inner circumferential edge of the upper end of the seat portion 23 in the drawing to block communication of the port 20a.

As illustrated in FIG. 2, a spring receiving member 25 movable in the axial direction with respect to the valve seat member 20 is provided in the small-diameter portion 11a of the communicating hole 11 located above the relief valve 2. The spring receiving member 25 includes a cylinder portion 25a in which the outer circumferential portion is screwed to the small-diameter portion 11a of the communicating hole 11, and an annular protrusion 25b which is provided to protrude in the axial direction from the inner circumferential portion of the cylinder portion 25a and functions as a spring receiver for receiving the opposite valve member side end of the urging spring S1.

Further, as illustrated in FIG. 2, a notch 25c into which a tool for rotating the spring receiving member 25 can be inserted is formed at the upper end of the cylinder portion 25a. Three horizontal holes 25d which open from the side and communicate with the inside of the cylinder portion 25a are arranged in the axial direction on the upper side of the annular protrusion 25b of the cylinder portion 25a in the drawing.

The urging spring S1 is a coil spring and is interposed between the annular protrusion 25b of the spring receiving member 25 and the valve body 21, and urges the valve body 21 toward the valve seat member 20 side. Specifically, a holder 26 is mounted to the lower end of the urging spring S1, and the urging spring S1 abuts against the valve body 21 via the holder 26.

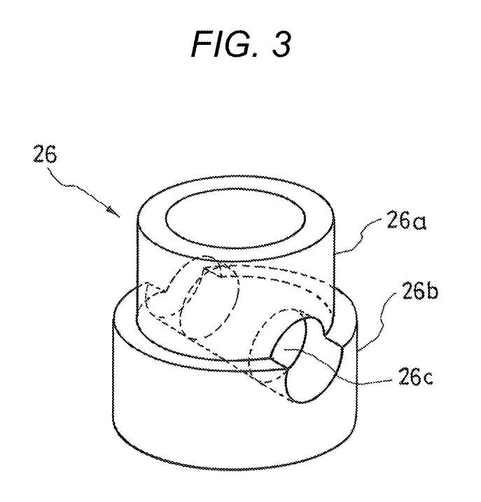

As enlarged in FIG. 3, the holder 26 has a cylindrical press-fitting portion 26a press-fitted to the lower end of the urging spring S1, and a disc-shaped abutting portion 26b which is provided at the lower end of the press-fitting portion 26a, has an outer diameter greater than that of the press-fitting portion 26a and abuts against the valve body 21. Further, as illustrated in FIG. 3, the holder 26 is provided with a through-hole 26c penetrating the holder 26 in the radial direction and communicating with the inside of the press-fitting portion 26a.

In the relief valve 2, the valve opening pressure is determined by the urging force of the urging spring S1 which urges the valve body 21 toward the valve seat member 20 side. In this example, the spring receiving member 25 which receives the upper end of the urging spring S1 is provided to be movable in the axial direction. Therefore, if the spring receiving member 25 is rotated and moved in the axial direction, since the axial position of the annular protrusion 25b changes, the initial load of the urging spring S1 changes and the urging force can be adjusted.

Therefore, since the valve opening pressure of the relief valve 2 is determined by the urging force of the urging spring S1, the spring receiving member 25 functions as an adjusting device capable of adjusting the valve opening pressure of the relief valve 2.

As will be described in detail later, the lock device 3 can be brought into a locked state in which the relief valve 2 is not opened and an unlocked state in which the relief valve 2 can be opened. In the unlocked state of the relief valve 2, when the air pressure in the air chamber G exceeds the valve opening pressure of the relief valve 2, since the valve body 21 separates from the seat portion 23 against the urging force of the urging spring S1 and the relief valve 2 opens, the air pressure in the air chamber G becomes the valve opening pressure of the relief valve 2.

Further, since the surface of the abutting portion 26b of the holder 26 which abuts against the valve body 21 is formed flat, the spherical valve body 21 can laterally slide. As a result, the valve body 21 is positioned only by the port 20a of the seat portion 23, and the relief valve 2 is reliably closed.

In the relief valve 2, a spherical one is used as the valve body 21, but the invention is not limited to this configuration.

Further, a lock nut 27 for locking the spring receiving member 25 is screwed onto the outer periphery of the spring receiving member 25 protruding from the communicating hole 11, so that the axial position of the spring receiving member 25 does not deviate.

Subsequently, the locked state of the lock device 3 will be described. As illustrated in FIG. 2, the lock device 3 includes a push rod 30 that is inserted into the spring receiving member 25 to be movable in the axial direction, a pressing spring S2 as an elastic member that abuts against the end opposite to the valve body side of the push rod 30 and presses the valve body 21 toward the valve seat member 20 via the push rod 30, and a cap nut 31 as a pressing member which abuts against the upper end which is the end opposite to the valve body side of the pressing spring S2 and is movable in the axial direction with respect to the valve seat member 20.

Describing in detail each part, the push rod 30 has a cylindrical shape, and the distal end thereof is inserted into the press-fitting portion 26a of the holder 26. Further, the push rod 30 is slidably inserted into the inner periphery of the annular protrusion 25b of the spring receiving member 25, and the axial movement of the push rod 30 is guided.

Further, the pressing spring 52 is a coil spring and is interposed between the cap nut 31 and the push rod 30, and urges the push rod 30 toward the valve seat member 20 side. Specifically, a spring holder 32 is mounted to the lower end of the pressing spring S2, and the pressing spring S2 urges the push rod 30 via the spring holder 32.

A groove 32a formed along the radial direction of the push rod 30 is provided at the lower end portion of the spring holder 32.

As described above, a bottomed cylindrical cap nut 31 is mounted on the outer periphery of the upper end of the spring receiving member 25 in FIG. 2. The cap nut 31 receives the upper end of the pressing spring S2 at the bottom portion 31a, the inner periphery of the cylinder portion 31b is screwed with the outer periphery of the spring receiving member 25, and the cap nut 31 can move in the axial direction with respect to the spring receiving member 25 in the manner of the feed screw. Thus, the spring receiving member 25 can move in the axial direction with respect to the valve seat member 20.

According to the above configuration, when the cap nut 31 as a pressing member is rotated in the tightening direction and moved downward in the drawing, since the bottom portion 31a of the cap nut 31 approaches the upper end of the push rod 30 and the pressing spring S2 moves a position in the contraction direction, the pressing spring S2 can be compressed. Then, the pressing spring S2 exerts an urging force, and the urging force acts on the valve body 21 via the push rod 30.

Therefore, since the urging force of the urging spring S1 and the pressing spring S2 acts on the valve body 21 of the relief valve 2, the relief valve 2 cannot be opened at the valve opening pressure determined by the urging spring S1, and the relief valve 2 is in a locked state.

Therefore, according to the lock device 3, the relief valve 2 can be maintained in the closed state even when the air pressure in the shock absorber main body 1 becomes the maximum atmospheric pressure under the use environment.

The urging force of the pressing spring S2 may be set to a force at which the relief valve 2 does not open even under the maximum atmospheric pressure in the shock absorber main body 1 under the use environment.

However, in this example, since the valve body 21 is urged by the urging spring S1 and the pressing spring S2, a total force of the urging force of the urging spring S1 and the pressing spring S2 acts on the valve body 21. Therefore, it is sufficient for the total force of the urging force of the urging spring S1 and the pressing spring S2 to be set to a force at which the relief valve 2 does not open even at the maximum air pressure inside the shock absorber main body 1 at least under the use environment.

In contrast, when the cap nut 31 is rotated in the loosening direction and moved upward in the drawing, since the bottom portion 31a of the cap nut 31 separates from the upper end of the push rod 30 and the pressing spring S2 is restored to its natural length, the urging force of the pressing spring S2 does not act on the valve body 21. Then, since the valve body 21 is urged only by the urging spring S1, the locked state is released, and the relief valve 2 is in an openable unlocked state.

That is, by moving the cap nut 31 as a pressing member in the axial direction, the lock device 3 can switch the relief valve 2 between the locked state and the unlocked state.

Since the cap nut 31 has a bottomed cylindrical shape, when the cap nut 31 is moved downward in the drawing to a position at which its lower end abuts against the upper end of the lock nut 27, communication between the horizontal hole 25d and the outside is cut off, and the inside of the communicating hole 11 can be sealed. Further, when the cap nut 31 is rotated in the loosening direction and moved in the upward direction in the drawing and moved to a position which does not block the horizontal hole 25d, since the horizontal hole 25d communicates with the outside, the inside of the communicating hole 11 communicates with the outside via the horizontal hole 25d.

Therefore, according to the above configuration, when the cap nut 31 is rotated in the loosening direction and moved in the upward direction in the drawing, the relief valve 2 is in the unlocked state, and the inside of the communicating hole 11 communicates with the outside via the horizontal hole 25d. Therefore, when the pressure in the air chamber G exceeds the valve opening pressure of the relief valve 2 in the unlocked state, the relief valve 2 opens, and the gas discharged from the air chamber G flows through the through-hole 26c of the holder 26, the inside of the push rod 30, the groove 32a of the spring holder 32, and the horizontal hole 25d, and is discharged outward.

Therefore, according to the above configuration, when the cap nut 31 is rotated in the loosening direction at the time of stop of vehicle and one of the horizontal holes 25d is moved until it communicates with the outside, the relief valve 2 is in the unlock state. Therefore, when the air pressure in the air chamber G in the shock absorber main body 1 exceeds the valve opening pressure of the relief valve 2 in the unlocked state, the relief valve 2 opens and the air pressure in the air chamber G becomes the valve opening pressure of the relief valve 2. Conversely, when the cap nut 31 is rotated in the tightening direction, the horizontal hole 25d is closed by the cap nut 31 to seal the inside of the communicating hole 11, and the relief valve 2 is in the locked state.

However, the pressing member of the present example is constituted by the cap nut 31 and is screwed and mounted on the outer periphery of the spring receiving member 25, and the method of mounting the pressing member is not limited thereto, and the pressing member may be mounted by a method in which it can move in the axial direction.

The configuration of the relief valve 2 and the lock device 3 of the above-described pressure regulating device A is merely an example, and is not limited to the above configuration. Further, in this example, the pressure regulating device A is provided in the communicating hole 11 opened in the cap member 10, but the position at which the pressure regulating device A is provided is not particularly limited, and the pressure regulating device A may be provided at a position other than the cap member 10.

As described above, the shock absorber D according to the present embodiment includes a shock absorber main body 1 in which the internal air pressure is set at a pressure exceeding the atmospheric pressure, a relief valve 2 which opens when the air pressure in the shock absorber main body 1 reaches the valve opening pressure, and a lock device 3 capable of maintaining the relief valve 2 in a closed state.

According to this configuration, since the air pressure of the air chamber G in the shock absorber main body 1 functioning as a suspension spring becomes the valve opening pressure of the relief valve 2, when the air pressure of the air chamber G in the shock absorber main body 1 rises and exceeds the valve opening pressure, the relief valve 2 opens to restore the air pressure of the air chamber G to the valve opening pressure of the relief valve 2. That is, in the shock absorber D of this example, since the rise in the air pressure inside the shock absorber main body 1 can be prevented, the air pressure in the air chamber G is easily adjusted.

In addition, since the relief valve 2 can be locked by the lock device 3 so as not to open, if the relief valve 2 is in the locked state during traveling of the vehicle, the relief valve 2 can be prevented from opening, even if the air pressure in the shock absorber main body 1 exceeds the valve opening pressure of the relief valve 2. Therefore, the gas in the shock absorber main body 1 escapes during traveling of the vehicle, and a situation in which the air pressure of the air chamber G drops does not occur.

Further, by being moved in the axial direction, the lock device 3 can switch the relief valve 2 between an unlocked state in which the relief valve 2 can be opened and a locked state in which the relief valve 2 is not opened.

Therefore, when injecting gas into the air chamber G in the shock absorber main body 1 via the air valve V, if the relief valve 2 is set to the unlocked state and gas is injected until the relief valve 2 opens, the gas pressure of the air chamber G can be set to the valve opening pressure of the relief valve 2. Therefore, in the shock absorber D of this example, it is not necessary to inject the gas, while measuring the air pressure of the air chamber G with the air gauge, and the gas injection operation becomes easy.

Further, by merely moving the lock device 3 in the axial direction and bringing the relief valve 2 into the unlocked state, the air pressure in the shock absorber main body 1 can be adjusted to the valve opening pressure of the relief valve 2. Therefore, it is not necessary to re-measure with the air gauge each time the air pressure in the shock absorber main body 1 rises, and if the vehicle is stopped and the lock device 3 is operated, the air pressure inside the shock absorber main body 1 can be easily restored to an appropriate value.

Further, the relief valve 2 has a valve seat member 20 having a port 20a communicating with the inside of the shock absorber main body 1, a valve body 21 separating from and seating on the valve seat member 20 to open and close the port 20a, and a urging spring S1 which urges the valve body 21 toward the valve seat member 20. The lock device 3 has a pressing spring S2 as an elastic member for pressing the valve body 21 toward the valve seat member 20, and a cap nut 31 as a pressing member which abuts against the end opposite to the valve body of the pressing spring S2 and is movable in the axial direction with respect to the valve seat member 20.

According to this configuration, since the cap nut 31 as the pressing member presses the valve body 21 via the pressing spring S2 as the elastic member, it is possible to avoid an excessive heavy load from being applied to the seat portion 23 of the valve seat member 20 when the relief valve 2 is locked. In addition, since the strength required for the valve seat member 20 is lowered, the selectivity of the material for forming the valve seat member 20 is improved.

In this example, a metallic spring is used as the elastic member, but the elastic member may be made of rubber or the like.

Furthermore, in this example, the pressing spring S2 presses the valve body 21 toward the valve seat member 20 via the push rod 30. However, the valve body 21 may be directly pressed toward the valve seat member 20 side with the pressing spring S2, without passing through the push rod 30.

However, if the valve seat member 20 is made of a material with high strength, the pressing spring S2 may be omitted and the valve body 21 may be pressed only by the push rod 30.

Further, although the push rod 30 of this example is formed in a cylindrical shape to form a gas passage inside, the push rod 30 may be formed solid. In this case, for example, a notch or a port for allowing the upper and lower sides in the drawing which are the air chamber G side and the atmospheric side to communicate with each other may be formed in the annular protrusion 25b to form a gas passage.

However, if the push rod 30 is formed in a cylindrical shape as in this example, since the inside can be used as a gas passage, it is not necessary to additionally provide a notch or a port. Further, as compared with a case where the push rod 30 is formed solid, since the weight is reduced, the weight of the shock absorber D can be reduced.

In addition, since the shock absorber D of this example is mounted on the vehicle, vertical vibration is input during traveling of the vehicle. Therefore, the push rod 30 also receives the vertical vibration and is pushed up and down. Here, the force of pushing the push rod 30 is proportional to the mass of the push rod 30. Since the push rod 30 of this example is lightweight as described above, even if the vertical vibration is input to the shock absorber D, the push rod 30 is hard to vibrate up and down. Therefore, even if a large vertical vibration is input while the vehicle is traveling, the push rod 30 of this example cannot move until it resists with the urging force of the pressing spring S2. Therefore, when the push rod 30 is formed in a cylindrical shape, it is possible to more reliably prevent such a situation that the locked state of the relief valve 2 is released during traveling of the vehicle.

Further, the shock absorber D of this example is provided with an adjusting device that can adjust the valve opening pressure of the relief valve 2. This adjusting device has a spring receiving member 25 which is capable of moving in the axial direction with respect to the valve seat member 20 and is capable of adjusting the urging force of the urging spring S1 which urges the valve body 21 by movement.

According to this configuration, since the valve opening pressure of the relief valve 2 can be adjusted only by changing the axial position of the spring receiving member 25, the air pressure in the shock absorber main body 1 can be easily adjusted to an arbitrary pressure.

However, the configuration of the adjusting device is not limited to one described above, and is not particularly limited as long as it has a configuration capable of adjusting the valve opening pressure of the relief valve 2.

Further, the spring receiving member 25 has a horizontal hole 25d that opens from the side and communicates with the inside of the shock absorber main body 1, and the horizontal hole 25d can be opened and closed by the cap nut 31, as a bottomed cylindrical cap which is mounted on the outer periphery of the spring receiving member 25 to be movable in the axial direction.

According to this configuration, merely by moving the cap nut 31 along the axial direction of the spring receiving member 25 to set the horizontal hole 25d to an open state, it is possible to easily adjust the air pressure inside the shock absorber main body 1 to the valve opening pressure of the relief valve 2.

Further, in this example, since three horizontal holes 25d are provided side by side in the axial direction, even if the axial position of the spring receiving member 25 moves to adjust the valve opening pressure of the relief valve 2, one horizontal hole 25d is disposed close to the upper side of the lock nut 27. Therefore, it is possible to always reduce the amount by which the cap nut 31 is moved in the axial direction when the horizontal hole 25d is made to communicate with the outside. In this example, although three horizontal holes 25d are provided, if one of the horizontal holes 25d is disposed close to the upper side of the lock nut 27 depending on the movement amount when adjusting the valve opening pressure, the number of the horizontal holes 25d is not particularly limited.

Further, since the relief valve 2 is brought into a locked state during traveling of the vehicle, the horizontal holes 25d are closed by the cap nut 31. Thus, there is no risk of entry of dust or muddy water from the horizontal holes 25d.

Further, the horizontal hole 25d provided in the spring receiving member 25 may be omitted and a hole communicating between the inside and the outside may be provided in the bottom portion 31a of the cap nut 31 so that the communicating hole 11 always communicates with the outside via the hole.

However, as in this example, when the cap nut 31 as a bottomed cylindrical cap is mounted to the outer periphery of the spring receiving member 25 to open and close the horizontal hole 25d, if the cap nut 31 closes the horizontal hole 25d, the atmosphere side opening of the communicating hole 11 is covered with a lock nut 27 and a cap nut 31 as a cap, and the inside of the communicating hole 11 is sealed. Therefore, when the relief valve 2 is locked, even if the valve body 21 of the relief valve 2 is displaced, a gap is formed between the valve body 21 and the seat portion 23 of the valve seat member 20, and the gas in the shock absorber main body 1 leaks from the gap, the gas can be temporarily retained inside the communicating hole 11, the lock nut 27 and the cap nut 31. Therefore, in the shock absorber D of this example, even if the relief valve 2 opens during traveling of the vehicle, the problem that the air pressure in the shock absorber main body 1 is immediately lowered is hard to occur.

Furthermore, if oil having high viscosity and high sealing performance such as grease is applied between the cap nut 31 and the lock nut 27 and between the lock nut 27 and the cap member 10, sealability inside the communicating hole 11 is improved.

In the present embodiment, the cap nut 31 also serves as a constitution of the pressing member capable of pressing the pressing spring S2 toward the valve seat member 20 and a cap for opening and closing the horizontal hole 25d, but the pressing member and the cap may be separately provided. However, as in this example, it is advantageous that the pressing member and the cap are formed as the cap nut 31 also serving as these configurations, since the number of parts can be reduced.

While the preferred embodiments of the present invention have been described in detail, it should be understood that alterations, variations and modifications can be made without departing from the scope of the claims.

For example, although the shock absorber D is used for a front fork in this example, it is not limited thereto, and the shock absorber D may be used for, for example, a rear cushion.

What is claimed is:

1. A shock absorber comprising:
a shock absorber main body in which an internal air pressure is set to a pressure exceeding an atmospheric pressure;
a relief valve configured to open when the air pressure in the shock absorber main body reaches a valve opening pressure; and
a lock device capable of maintaining the relief valve in a closed state.

2. The shock absorber according to claim 1, wherein
the lock device is capable of, by being moved in an axial direction of the shock absorber main body, switching the relief valve between an unlocked state in which the relief valve can be opened and a locked state in which the relief valve is not opened.

3. The shock absorber according to claim 2, wherein
the relief valve includes a valve seat member including a port communicating with an inside of the shock absorber main body, a valve body which separates from and seats on the valve seat member to open and close the port, and an urging spring which urges the valve body toward the valve seat member, and
the lock device includes an elastic member configured to press the valve body toward the valve seat member side, and a pressing member which is in contact with an end opposite to the valve body side of the elastic member and is movable in the axial direction with respect to the valve seat member.

4. The shock absorber according to claim 1, further comprising:
an adjusting device capable of adjusting the valve opening pressure of the relief valve.

5. The shock absorber according to claim 2, wherein
the adjusting device includes a spring receiving member which supports the opposite valve seat member side of the urging spring and is movable in the axial direction with respect to the valve seat member.

6. The shock absorber according to claim 5, wherein
the spring receiving member includes a horizontal hole which opens from a side and communicates with the inside of the shock absorber main body, and a cap is mounted to an outer circumference, and
the cap is opened and closed by moving the cap along the axial direction of the spring receiving member.
